(19) United States
(12) Patent Application Publication
(10) Pub. No.: US 2020/0290432 A1
(43) Pub. Date: Sep. 17, 2020

(54) AIR VENTS FOR THE INTERIOR OF A MOTOR VEHICLE

(71) Applicant: GRAMMER Interior Components GmbH, Hardheim (DE)

(72) Inventor: Peter Stehle, Rosbach (DE)

(21) Appl. No.: 16/800,194

(22) Filed: Feb. 25, 2020

(30) Foreign Application Priority Data
Mar. 11, 2019 (DE) DE102019106086.9

(51) Int. Cl. B60H 1/34; B60H 1/24; B60H 1/00

(52) U.S. Cl. CPC B60H 1/3407; B60H 1/00871; B60H 1/242

(57) ABSTRACT

An air vent for an interior of a motor vehicle, the air vent including a housing including a longitudinal housing axis; an air outlet opening formed by the housing; at least one air louver that is arranged in the housing and that directs an air flow that exits from the air outlet opening, wherein the air outlet opening is provided with an expanded metal cover that includes loops that are enveloped by bars that include bar walls, wherein the bar walls are arranged at a bar wall angle relative to the longitudinal hosing axis, wherein the at least one air louver is arranged at an air louver angle relative to the longitudinal housing axis and includes a proximal air louver edge that is proximal to the expanded metal cover and a distal air louver edge that is distal from the expanded metal cover.

### RELATED APPLICATIONS

This application claims priority from and incorporates by reference German Patent Application DE 10 2019 106 086.9 filed on Mar. 11, 2019.

### FIELD OF THE INVENTION

The invention relates to an air vent for the interior of a motor vehicle, the air vent including a housing including a longitudinal housing axis, an air outlet opening formed by the housing, a louver that is arranged in the housing and that directs an air flow that exits from the air outlet opening.

### BACKGROUND OF THE INVENTION

Air vents of this generic type are well known in the art and provide an air flow into an interior of the motor vehicle e.g. in order to dry condensation at a wind screen. Air vents of this type configured as defrosters include air outlet openings and at least one fixed louver which directs an air flow onto the wind screen and which is subject to strict regulations regarding its performance.

EP 3 164 280 B1 discloses generic air vents that include horizontal and vertical louvers that are pivotably arranged in a housing and nested in one another in a cross over arrangement. Air vents of this type are installed e.g. in a dash board or in a side fairing in an interior of the vehicle and enable passengers to direct the air flow in a controlled and comfortable manner.

In view of upcoming partially or completely autonomous driving operations car manufacturers put more emphasis on an esthetic configuration of the vehicle interior recently in order to create a comfortable environment for passengers. Uniform surfaces are perceived particularly esthetic and high quality since the uniform surfaces integrate the interior design. Known air louvers, however, include air outlet openings which break the desired optical uniformity of the dash board and significantly degrade the overall esthetics of the vehicle interior.

In addition to the optical breakup air vents bear the risk that objects placed onto the dashboard can fall into the air outlet openings so that a function of the air vents is substantially degraded. Removing the objects can be very complicated.

### BRIEF SUMMARY OF THE INVENTION

Thus, is it an object of the invention to provide an air vent which complies with performance regulations while providing full functionality and that prevents a penetration of objects and satisfies advanced requirements with respect to interior design.

In other fields expanded metals and structures e.g. made from synthetic materials that imitate expanded metals are known. These structures are used e.g. for large surface covering of the dash board or of speaker openings and thus provide a uniform surface that is particularly pleasing to the eye. Covering the air vents is generally avoided since this would convert the directed air flow into a diffuse air flow. Thus, the defrosters would not be able to deliver the prescribed performance. Covers made from expanded metal or structures that imitate expanded metals are therefore not used on other air vents either.

The object is achieved by air vent for an interior of a motor vehicle, the air vent including a housing including a longitudinal housing axis; an air outlet opening formed by the housing; at least one air louver that is arranged in the housing and that directs an air flow that exits from the air outlet opening, wherein the air outlet opening is provided with an expanded metal cover that includes loops that are enveloped by bars that include bar walls, wherein the bar walls are arranged at a bar wall angle relative to the longitudinal hosing axis, wherein the at least one air louver is arranged at an air louver angle relative to the longitudinal housing axis and includes a proximal air louver edge that is proximal to the expanded metal cover and a distal air louver edge that is distal from the expanded metal cover, wherein the proximal air louver edge is arranged close enough to the expanded metal cover so that an air flow that exits the expanded metal cover has a defined or laminar orientation, and wherein an orientation of the air flow that exits the expanded metal cover is a resultant of the air louver angle and the bar wall angle.

The invention overcomes a prejudice in the art that expanded metals do not direct air flow. It has come as a surprise that the directed air flow maintains its defined orientation in spite of flowing through the expanded metal. Comprehensive tests have shown that the directed air flow is maintained after passing through the expanded metal when an edge of the louver that is proximal to the expanded metal extends to the expanded metal cover while only leaving a small clearance between the louver and the expanded metal cover that is required for assembly. Thus, the performance of the defroster is not degraded by arranging the expanded metal cover at the air outlet opening of the air vent and continues to comply with performance regulations.

The air vent according to EP 3 164 280 B1 can also be provided with an expanded metal cover of this type. Also here the air flow remains directed after passing through the expanded metal cover when care is taken that the louver edge that is proximal to the expanded metal extends close enough to the expanded metal cover so that only an assembly clearance remains between the expanded metal and the louver edge that is proximal to the expanded metal. Thus, the invention overcomes the persistent prejudice in the art that an air flow that passes through the expanded metal cover cannot be directed.

The invention also eliminates the risk of objects getting into the air vents. The loops of the expanded metal cover are spaced close enough so that only objects with minimal size that cannot impair the function of the air vent can penetrate.

The structure of the expanded metal cover is particularly advantageous. It is pleasing to the eye and complies with stringent optical requirements of vehicle manufacturer's with respect to vehicle interior. Since defrosters and other air vents can be covered by the expanded metal without any problem and without losing functionality of the air vent the entire dash board can be configured with large and uniform surfaces which optimizes the entire interior design of the motor vehicle.

In an advantageous embodiment the at least one louver is pivotably arranged in the housing about an axis so that a louver angle relative to a longitudinal axis of the housing is adjustable. It is also provided that the pivot axis of the louvers is arranged proximal to the expanded metal so that a distance between the a louver edge and the expanded metal cover that increases through the pivot movement of the louvers still facilitates an air flow that exits from the cover in a controlled direction. The air flow is initially oriented by the pivotable louvers in an interior of the housing and deflected thereafter at the expanded metal cover without turbulences occurring between the louver and the expanded metal cover. Thus the air flow is conducted into the interior of the motor vehicle in an oriented manner.

It is furthermore provided that the edge that is proximal to the expanded metal terminates into a louver edge and that the pivot axis essentially coincides with the louver edge. It is particularly advantageous in this embodiment that a distance between the louver edge and the expanded metal cover is reduced to a minimum in spite of the pivot movement of the louver. Therefore the air flow that exit is from the expanded metal cover can be controlled in its direction.

It is furthermore conceivable to arranged plural parallel louvers in the housing. An orientation of the air flow by plural louvers that are oriented parallel to each other is advantageous since the air flow can exit the air vent with a very uniform orientation. In another embodiment of the air vent it is advantageously provided that the expanded metal cover has a convex or a concave curvature with a plane of curvature that is oriented parallel to a pivot axis of the louver. The curvature of the expanded metal cover can be e.g. convex or concave and can have a constant radius so that the curvature is cylindrical. A curvature with a variable radius, e.g, an oval curvature is also conceivable,

The convex as well as the concave curvature of the expanded metal cover causes a deflection of the exiting air flow so that novel flow patterns can be generated. The air flow that is deflected at a convex cambered expanded metal cover is released into the passenger compartment in a fan shape. Fanning of this type causes a large area flow towards the passengers or towards the wind screen. Thus, a larger surface can be covered with air in a short time period. The intensity of the air flow can decrease which is particularly comfortable for a passenger.

Contrary thereto a concave cambered expanded metal cover concentrates the exiting air flow and provides a precise linear orientation of the air flow. This linear exiting air flow can be directed in a controlled manner onto a spot on the windshield that is covered with condensate in order to quickly dry the spot. Thus the concave cambered expanded metal cover provides a precise and effective ventilation of the passenger compartment.

It is furthermore provided that the air flow is oriented by a combination of a cambered expanded metal cover and louvers arranged behind the cambered expanded metal cover. This combination facilitates an individual orientation of the air flow for the passenger wherein the air flow is easily adaptable to any situation.

It is furthermore conceivable that the bar walls of the cambered expanded metal cover respectively define a plane and that the plane respectively intersects the longitudinal housing axis, wherein a respective intersection angle of the plane and the longitudinal housing axis increases with an increasing distance of the respective bar walls from the longitudinal housing axis.

It is furthermore conceivable that the intersection angle variation is constant from intersection angle to intersection angle like for a cylindrical configuration of the expanded metal cover. However, it is also possible that an absolute amount of intersection angle variation differs from intersection angle to intersection angle like in a cambered expanded metal cover with variable radius.

In an advantageous embodiment of the invention the air vent is configured as a defroster for a wind screen of a motor vehicle, however, applications in any type of air vent are conceivable.

### BRIEF DESCRIPTION OF THE DRAWINGS

Further advantages and a better comprehension of the invention can be derived from the subsequent description of advantageous embodiments with reference to a drawing figure, wherein:

FIG. 1 illustrates a perspective view of an air vent with an expanded metal cover;

FIG, 2 illustrates a first embodiment of the air vent cut along section lines A-A in FIG. 1 with fixed air conducting louvers;

FIG. 3 illustrates a second embodiment of the air vent cut along section lines A-A in FIG. 1 with pivotable air conducting louvers;

FIG. 4 illustrates a sectional view of the second embodiment of the air vent according to the section line A-A in FIG. 1 with air louvers that are pivoted relative to a longitudinal housing axis;

FIG. 5 illustrates a blown up detail of an expanded metal cover to show the principle of an air vent that produces an air flow parallel to a housing axis;

FIG. 6 illustrates a blown up detail of the expanded metal cover to illustrate the principle of an air vent with a deflected air flow;

FIG. 7 illustrates a sectional view of a third embodiment with a convex cambered expanded metal cover; and

FIG. 8 illustrates a sectional view of a fourth embodiment of the air louver with a concave cambered expanded metal cover

### DETAILED DESCRIPTION OF THE INVENTION

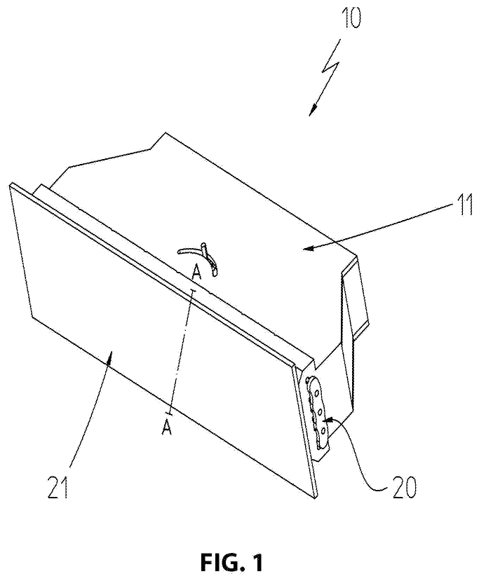

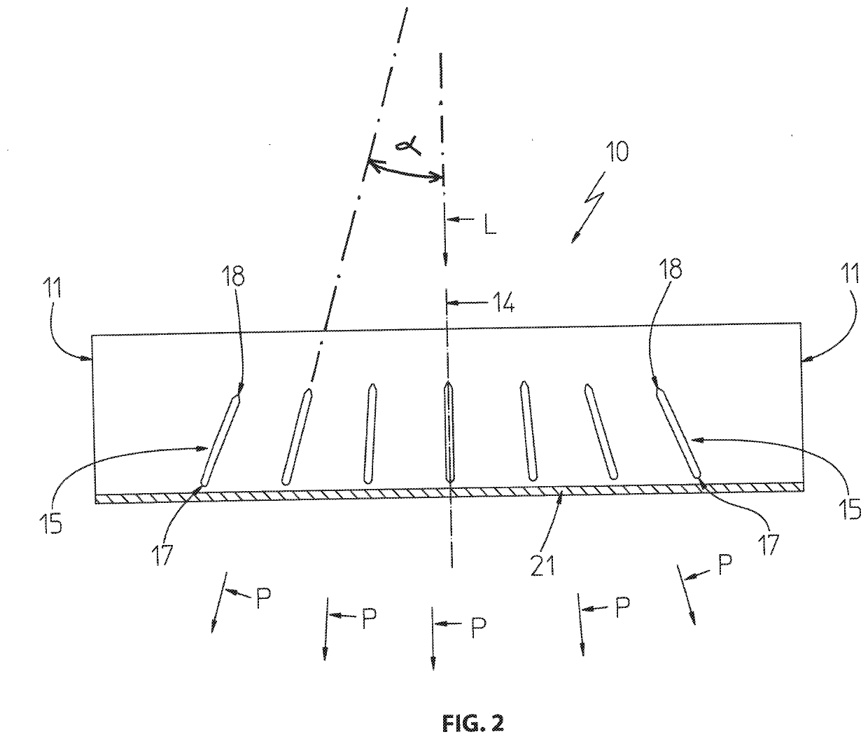

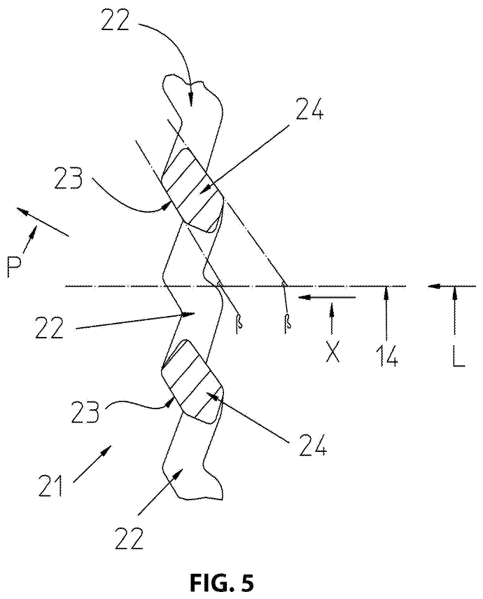

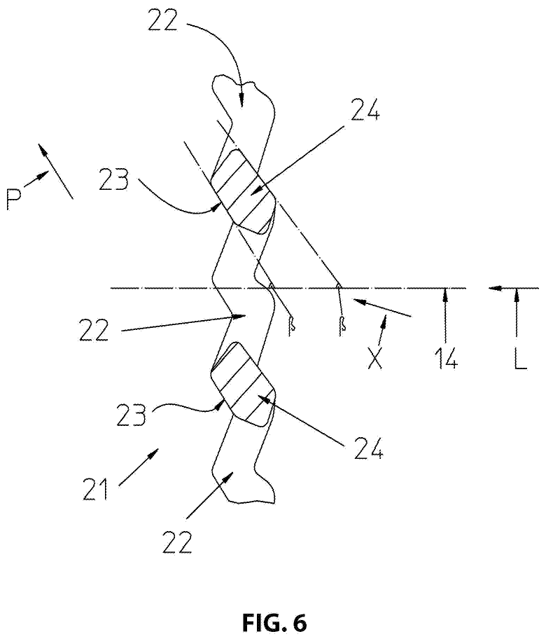

The air vent according to the invention is illustrated in its entirety in FIGS. 1 4 and 7-8 and is overall designated with the reference numeral 10, FIGS. 5 and 6 show an operating principle of the air vent according to the invention.

FIGS. 1-4 show the air vent 10 including a housing 11 that forms an air outlet opening 12 and air inlet opening 13. A longitudinal housing axis 14 extends in the housing 11 from the air inlet opening 13 to the air outlet opening 12 parallel to an air flow L, c.f. FIGS. 2-8.

Air louvers 15 arranged in the housing 11 are illustrated in FIGS. 1-8. The air louvers 15 include an air louver edge 17 that is proximal to the air outlet opening and an air louver edge 18 that is distal from the air outlet opening. The air flow L that exits the air outlet opening 12 is oriented by the air louvers 15. The air louvers 15 respectively enclose an air louver angle α with the longitudinal housing axis 14.

In FIG. 2 the air louvers 15 are arranged in the housing 11 non-movable in a fan shape which is typical for a defroster. This arrangement puts a fanned air flow onto the wind screen in order to dry condensation at the wind screen.

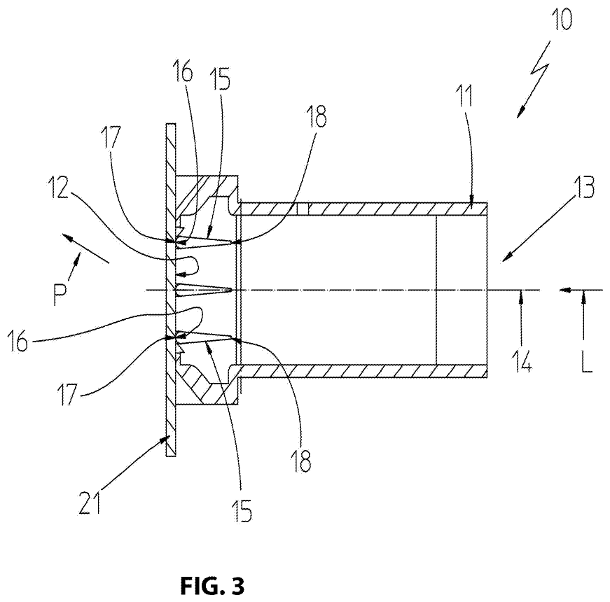

FIGS. 3-8 illustrate an air vent 10 providing ventilation for an interior of a motor vehicle and including air louvers 15 that are oriented parallel to each other and that are arranged in the housing 11 and pivotable about a pivot axis 16. The pivot axis 16 coincides substantially with the air louver edge 17 that is proximal to the air outlet opening. The air louvers 15 are pivotable in the housing 11 by a control element 20 (c.f. FIG. 1). The air louvers 15 are combined into a louver group.

The air louver angle α is a function of an orientation of the air louvers in the housing 11.

It is appreciated that the air vent 10 can include a second air louver group in addition to the first air louver group wherein the air louvers 15 of the second air louver group are arranged orthogonal to the air louvers 15 of the first air louver group in the housing 11.

The air outlet opening 12 of the air vent 10 is provided with an expanded metal cover 21 in FIG. 2 and in FIGS. 3-8.

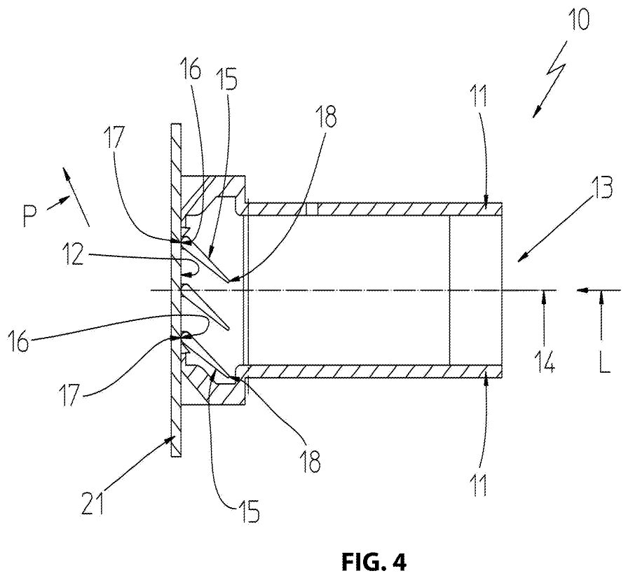

FIGS. 3 and 4 illustrate a second embodiment of the air vent 10. The air louvers 15 of this air vent 10 are movably arranged in the housing 11.

In FIG. 3 the air louvers 15 are arranged parallel to the longitudinal housing axis 14 with respect to an outflow direction. The air flow L is influenced only by the expanded metal cover 21 with respect to an outflow direction of the airflow. The deflection of the air flow L is represented by the directional arrow P.

In FIG. 4 the air louvers 15 are pivoted relative to the longitudinal housing axis 14 and enclose a louver angle α greater than 0° with the longitudinal housing axis 14. Thus, the air flow L is flowed pre oriented to the expanded metal cover 21 so that the air flow L exits the expanded metal cover 21 according to the arrow P. In this embodiment the air louvers 15 as well as the expanded metal cover 21 influence an exit direction of the air flow L from the expanded metal cover 21

A function of the air vent according to the invention is now described with reference to FIGS. 5 and 6.

FIGS. 5 and 6 illustrate the expanded metal cover 21 in a highly magnified detail. FIGS. 5 and 6 show an operating principle of the expanded metal cover. It is evident that the expanded metal cover 21 includes openings configured as loops 22 that are enveloped by bars 23. The bars 23 are fabricated at a slant angle in the expanded metal cover 21. The bars 23 form bar walls 24 that enclose a bar wall angle β with the longitudinal housing axis 14. The bar wall angle is greater than 0° and less than 90°. In an advantageous embodiment the bar wall angles β are between 20° and 70°. In the illustrated embodiment the bar wall angles β are approximately 45°.

FIG. 5 illustrates the air inflow direction of the air vent 10 with the arrow X which is oriented parallel the longitudinal housing axis.

The bar wall angles β of the bar walls 24 of the expanded metal cover 21 have a first angular amount. The bar wall angles β in this embodiment have the amount of approximately 45° with respect to the longitudinal housing axis 14. The air flow L which is oriented parallel to the longitudinal housing axis coming from the air inlet opening 13 is flowed towards the bar walls 24 of the expanded metal cover 21. The pre oriented air flow L is now additionally oriented by the bar wall angle β at the bar walls 24. In this embodiment the resultant is approximately 45°. A direction of an air flow L that exits the expanded metal cover 21 is represented by the directional arrow P.

In FIG. 6 the air inflow direction of the air vent 10 is indicated by the arrow X wherein the air flow L goes through a first deflection with respect to the longitudinal housing axis 14. In this embodiment the deflection is approximately 30°. The pre oriented air flow L then flows along the bar walls 24 of the expanded metal cover 21, The bar walls 24 are oriented at a bar wall angle β. In this particular embodiment the bar wall angles β are approximately 45°. Thus, the air flow L goes through a second deflection at the expanded metal cover 21 so that the resulting air flow exits the expanded metal cover 21 according to the illustrated directional arrow P.

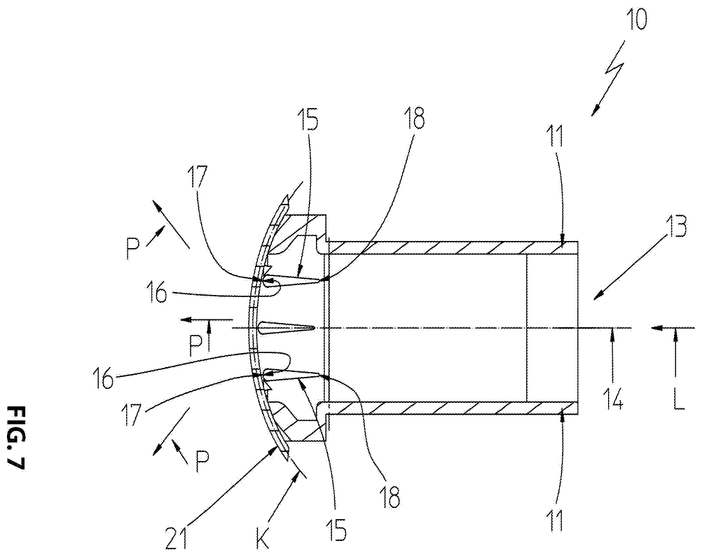

FIG. 7 illustrates another embodiment of the air vent 10. This embodiment shows a cylindrical convex expanded metal cover 21 that is arranged at the air outlet opening 12. The convex camber of the expanded metal cover 21 has a plane of camber K which is oriented parallel to a pivot axis 16 of the air louvers 15.

The air louvers 15 of the air vent 10 are arranged in the housing 11 parallel to the longitudinal housing axis 14 so that the air flow L is conducted pre oriented parallel to the longitudinal housing axis 14 to the convex cambered expanded metal cover 21.

The bar wall angle of the non-illustrated bar walls 24 (c.f. FIGS. 5 and 6) increases with increasing distance from the longitudinal housing axis 14. The bar walls 24 that are introduced into the expanded metal cover 21 at identical distance from the longitudinal housing axis 14 have an identical absolute value of bar angle.

The bar walls 24 spread the air flow L due to the different bar wall angles β so that the air flow L that exits the expanded metal cover 21 is exhausted into a vehicle interior in a fan shape. Thus, passengers or a wind screen can be subjected to a large area air flow.

When the air flow L is pre directed at the air louvers 15 that are pivoted relative to the longitudinal housing axis 14, a spread of the air flow that exits in the fan shape remains identical, however, an overall outflow direction of the air flow from the expanded metal cover 21 is changed. An air vent 10 of this type provides an individual the adjustment for passengers in order to generate an atmosphere with optimum comfort.

In another advantageous embodiment the expanded metal cover 21 is not cylindrical convex but oval convex which facilitates a different fan spread of the air flow L.

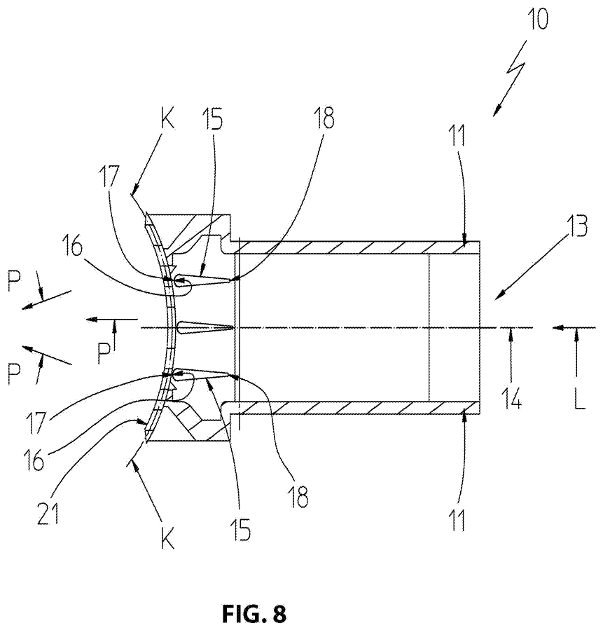

FIG. 8 illustrates another embodiment of the air vent 10. The expanded metal cover 21 is cambered cylindrical concave. This concave camber of the expanded metal cover 21 includes a plane of camber K which is oriented parallel to the pivot axis 16 of the air louvers 15.

Also in this embodiment the absolute value of the bar wall angle of the bar walls 24, c.f. FIGS. 5 and 6, increases with an increasing distance from the longitudinal housing axis 14. The bar walls 24 with identical distance from the longitudinal housing axis 14 have an identical absolute value of bar wall angles β.

The air louvers 15 behind the expanded metal cover 21 are oriented parallel to the housing axis so that also the air flow L at the air louvers 15 is pre oriented parallel to the housing axis. The cylindrical concave cambered expanded metal cover 21 directs the air flow L according to the respective bar wall angles β of the expanded metal cover 21 so that the air flow L that exits from the expanded metal cover 21 is laminar. This laminar air flow L that is represented by the arrow P can be oriented in a controlled manner e.g. to a spot that is covered with condensation at a wind shield in order to quickly dry the wind shield and thus facilitates a very precise and effective ventilation of an interior of a motor vehicle. Alternatively people in the interior can be subjected to a spot flow.

An advantageous embodiment relates to an air vent 10 wherein an air flow L is oriented by a combination of pivoted air louvers 15 and a concave cambered expanded metal cover 21. The laminar air flow that exits the expanded metal cover 21 can thus be directed in its entirety as a function of a pivot angle of the air louvers 15. Accordingly also the air louver 10 of FIG. 7 optimizes a comfortable atmosphere for the passenger.

In another advantageous embodiment the expanded metal cover 21 is not configured cylindrical concave but oval concave so that different flow patterns of the air flow L can be provided.

It is also possible to provide the expanded metal cover 21 spherical convex or spherical concave.

The air flow L that is deflected at the spherical convex expanded metal cover 21 is released into the passenger compartment cone shaped and provides a particularly large area flow into the passenger compartment.

The air flow L that is deflected at a spherical concave expanded metal cover 21 is released into the passenger compartment in a cone shape and subsequently focused at a point. This air flow L that is deflected into the point provides particularly precise ventilation.

The air vent 10 according to the invention provides an individually controllable air flow for passengers in a vehicle interior so that the air flow can be adapted to virtually any situation.

### REFERENCE NUMBERALS AND DESIGNATIONS

10 air vent

11 housing

12 air outlet opening

13 air inlet opening

14 longitudinal housing axis

15 air louver

16 pivot axis

17 air louver edge proximal to air outlet opening

18 air louver edge distal from air outlet opening

20 control element

21 expanded metal cover

22 loop

23 bar

24 bar wall

K curvature plane

L air flow

P directional arrow

X directional arrow

α air louver angle

β bar wall angle

What is claimed is:

1. An air vent for an interior of a motor vehicle, the air vent comprising:
a housing including a longitudinal housing axis;
an air outlet opening formed by the housing;
at least one air louver that is arranged in the housing and that directs an air flow that exits from the air outlet opening,
wherein the air outlet opening is provided with an expanded metal cover that includes loops that are enveloped by bars that include bar walls,
wherein the bar walls are arranged at a bar wall angle relative to the longitudinal hosing axis,
wherein the at least one air louver is arranged at an air louver angle relative to the longitudinal housing axis and includes a proximal air louver edge that is proximal to the expanded metal cover and a distal air louver edge that is distal from the expanded metal cover,
wherein the proximal air louver edge is arranged close enough to the expanded metal cover so that an air flow that exits the expanded metal cover has a defined orientation, and
wherein the orientation of the air flow that exits the expanded metal cover is a resultant of the air louver angle and the bar wall angle.

2. The air vent according to claim 1, wherein the at least one air louver is arranged in the housing pivotable about an air louver pivot axis so that the air louver angle is adjustable.

3. The air vent according to claim 2, wherein the air louver pivot axis is arranged proximal to the expanded metal cover so that a distance between the proximal air louver edge and the expanded metal cover that is increased by a pivot movement of the air louver facilitates the air flow that exits the expanded metal cover with the defined orientation.

4. The air vent according to claim 2, wherein the proximal air louver edge coincides with the air louver pivot axis.

5. The air vent according to claim 1, wherein the at least one air louver includes plural air louvers arranged parallel to each other in the housing.

6. The air vent according to claim 1, wherein the expanded metal cover has a convex or a concave curvature to form a cambered expanded metal cover with a plane of curvature that is oriented parallel to the air louver pivot axis.

7. The air vent according to claim 6,
wherein the bar walls of the cambered expanded metal cover define respective bar wall planes,
wherein the respective bar wall planes intersect with the longitudinal housing axis,
wherein absolute values of intersection angles of the respective bar wall planes with the longitudinal housing axis increase with an increasing distance of the bar walls from the longitudinal housing axis.

8. The air vent according to claim 7, wherein absolute values of intersection angle changes from one respective bar wall to an adjacent respective bar wall are constant.

9. The air vent according to claim 7, wherein absolute values of intersection angle changes from one respective bar wall to an adjacent respective bar wall vary.

10. The air vent according to claim 1, wherein the air vent forms a defroster for a wind screen of a motor vehicle.

11. The air vent according to claim 1, wherein the air flow that exits the expanded metal cover is laminar.

12. The air vent according to claim 1, wherein the bar wall angle is between 20° and 70°.
